(19) United States
(12) Patent Application Publication
(10) Pub. No.: US 2003/0202776 A1
(43) Pub. Date: Oct. 30, 2003

(54) Continuous digital recording through channel changes with user selectable buffer erase

(76) Inventors: Scott Allan Kendall, Westfield, IN (US); Carolynn Rae Johnson, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/173,541

(22) Filed: Jun. 17, 2002

Related U.S. Application Data
(60) Provisional application No. 60/375,135, filed on Apr. 24, 2002.

(51) Int. Cl. H04N 5/76; G11B 15/04; G11B 19/04

(52) U.S. Cl. 386/94; 360/60

(57) ABSTRACT

A method and a system for maintaining user privacy in a device (100) that continuously buffers video programming responsive to changes in a user selected video channel. Video programming can be continuously recorded on a storage medium (148) and presented on a display device. Recording can continue uninterrupted during and subsequent to a user change of the selected video channel. Responsive to a user input, at least a portion of the video programming that has been stored on the storage medium (148) can be deleted. The user input can be a single command input such as an actuation of a control key. The selected portion of the video programming that is deleted can be controlled by a pre-determined number of actuations of the control key. All of the video programming also can be deleted from the data storage medium. An interactive erase menu can provide menu selections for various erasing options.

### BACKGROUND OF THE INVENTION

1. Technical Field

The present invention relates to the field of digital video recording, and more particularly to buffering of video data in personal video recorders.

2. Description of the Related Art

Modern day digital video recorders allow users to a view broadcast program on a delayed schedule, even while the broadcast still continues. The digital video recorders typically buffer the program by recording the program to a data storage medium as the broadcast is received. After recording of a broadcast program has commenced, a user can begin playback of the recorded portion of the program. If a user chooses, he can pause this playback while the remainder of the program continues to be recorded from the broadcast. The user then can recommence playback of the recorded program from where it was paused. Further, the user also can perform other trick modes on the recorded portion of a program, for example fast forward and rewind.

A typical personal video recorder purges the buffered portion of a program when the user changes channels. This is usually accomplished by erasing the portion of the program stored to the data storage medium. One reason for deleting the buffer in the event of a channel change concerns a matter of viewer privacy. If the buffered portion of a program is not purged when the user changes channels, offensive content may be left on the personal video recorder. For example, when an adult is viewing programming inappropriate for children from a channel that has been locked for adult viewing only, inappropriate content may be left in the storage of the personal video recorder. Hence, a user who changes a channel typically is not able to review program content recorded from a previously viewed channel. This can be inconvenient if a user wishes to review a news story or a sports play that was buffered by the recorder prior to a channel change.

### SUMMARY OF THE INVENTION

The present invention relates to a method and a system for maintaining user privacy with a device that continuously buffers or stores audio/video programming responsive to a user selected video channel. The method includes continuously recording the video programming on a storage medium and concurrently providing the video programming to a display device. Recording can continue uninterrupted during and subsequent to a user change of the selected video channel.

Responsive to a user input, at least a portion of the video programming that has been stored on the storage medium can be deleted. The user input can be a single command input such as an actuation of a control key. In another arrangement the selected portion of the video programming that is deleted can be controlled by a pre-determined number of actuations of the control key. In yet another arrangement all of the video programming can be deleted from the storage medium.

Responsive to a user input, an interactive erase menu comprising a list of erase options also can be presented on a video display. The list of erase options can include a first menu selection providing for the erase of user specified program segments, a second menu selection providing for the erase of programming within user specified time frames, and a third menu selection providing for the erase of all recorded programming.

### BRIEF DESCRIPTION OF THE DRAWINGS

FIG. 1 is a block diagram of a personal video recorder incorporating continuous recording through channel changes and user selectable buffer erase in accordance with the present invention.

FIG. 2 is a flow chart showing the method of providing user selectable buffer erase in accordance with the present invention.

### DETAILED DESCRIPTION

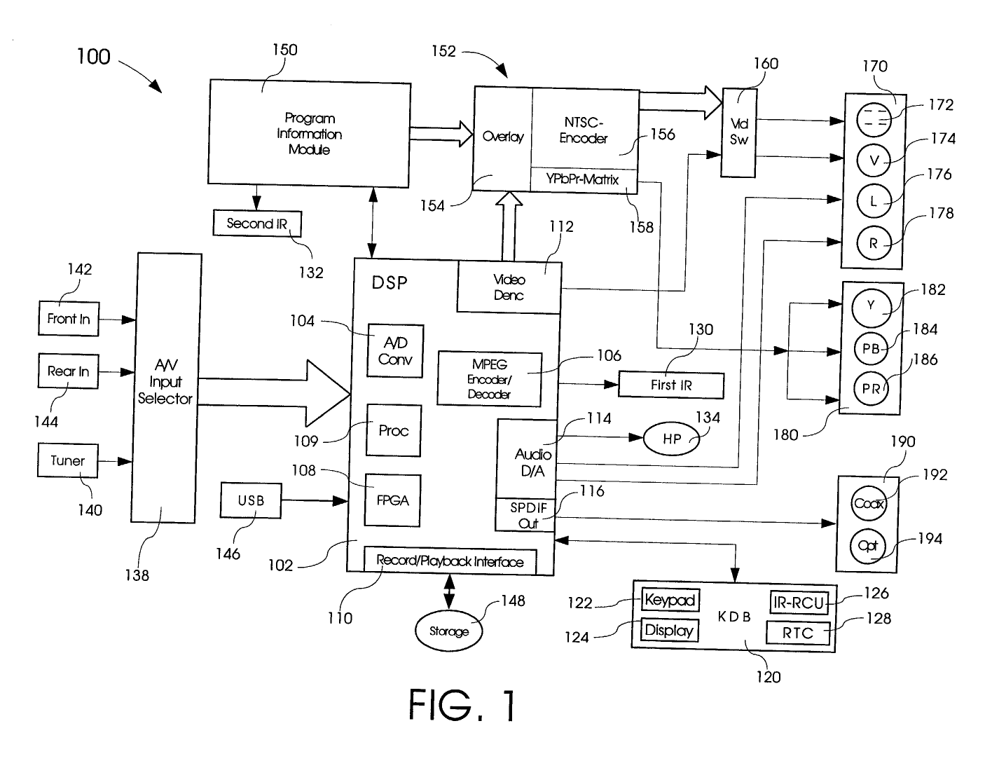

FIG. 1 is an exemplary block diagram of a personal video recorder (PVR) 100 that can implement continuous recording through channel changes and facilitate user selectable buffer erase. The personal video recorder (PVR) 100 can include a digital signal processor (DSP) 102, a key and display board 120, a tuner 140, an audio/video (A/V) input selector 138, a USB input 146, a storage device 148 and a program information module 150. Additionally, PVR 100 can include first and second infra-red (IR) links 130 and 132, a video overlay encoder 152, a video switch 160, a headphone jack 134, a standard A/V component connector block 170, a Y Pb Pr component video connector block 180, and a Sony/Phillips digital interface (SPDIF) connector block 190.

The component signal connector blocks 170, 180 and 190 can provide audio/video signals in a variety of output formats. For example, the standard A/V component connector block 170 can comprise an S-video connector 172 for outputting to a video display video that has been separated into chrominance and luminance video signals and a composite video connector 174 for providing an composite encoded video signal. Further, the standard A/V component connector block 170 can comprise left and right audio output connectors, 176 and 178, respectively.

The Y Pb Pr component signal connector block 180 is typically used for high definition television (HDTV). The Y Pb Pr component connector block 180 comprises a video luminance (Y) output connector 182 for providing an analog video luminance component, a Pb output connector 184 for providing a blue analog color difference (B-Y), and a Pr output connector 186 for providing a red analog color difference (R-Y). Lastly, the SPDIF component connector block 190 comprises a coaxial output 192 and an optical output 194 for outputting digital audio signals via a coaxial cable or fiber optic cable, respectively.

The key and display board 120 can be provided as a user interface for the PVR 100 and can incorporate a keypad 122, a display 124, an IR remote control interface 126 and a real time clock 128. By using the keypad 122 or the IR remote control interface 126, a user can select functions to be executed by PVR 100. For example, a user can choose to change channels on the PVR or to perform trick mode playback. The real time clock 128 can keep time, which can be shown by the display 124. The display 124 also can show other information as well, for example a trick mode being executed by the PVR, a selected channel being recorded by the PVR 100, or an identifier representative of a presentation being shown on a video display.

First and second IR links 130 and 132 form a set of communication links between satellite and non-satellite applications to help simplify the interface between the audio, video, and data streams. The first IR link 130 can provide a communication interface between DSP 102 and other devices having an IR communication link. Notably, the first IR Link 130 can be useful for controlling other devices designed specifically for RF or cable television broadcasts or radio broadcasts using standard program guide information. Link 130 can also enable features to simplify the consumer's interaction between devices. For example, the first IR link 130 can enable one touch program recording, as well as other user conveniences. The second IR link 132 can provide an interface between the program information module 150 and other devices having IR communication links. Significantly, the second IR link 132 can be useful for communicating with devices not requiring a direct connection to DSP 102, for example with a cable reception device, a VCR, etc.

Digital signal processor 102 can comprise an analog to digital (A/D) converter 104, an MPEG encoder/decoder 106, a field programmable gate array (FPGA) 108, a micro controller 109, a recorder/playback interface 110, a video digital encoder 112, an audio digital to analog converter (audio D/A) 114 and a SPDIF output 116. The DSP 102 can further include one or more data busses enabling the different DSP components to communicate with each other and cooperatively process data. Notably, interrupt requests (IRQs) and direct memory addresses (DMAs) can be utilized to facilitate bus communications and data processing.

Audio/Video (A/V) input selector 138 can include a plurality of A/V inputs. For example, the input selector 138 can incorporate an A/V input to receive A/V signals from tuner 140. The input selector also can receive signals from various other input devices as well. For example, a video camera can send A/V signals to the input selector 138 via front A/V input 142, and a VCR can send A/V signals via rear A/V input 144. Significantly, other A/V devices can be connected to the A/V input selector 138 as well.

The A/V input selector 138 couples the selected, received A/V signals to DSP 102. Analog to digital converter 104 can be used to convert A/V signals received in an analog format to a digital format. Audio/Video signals already in digital format can bypass the analog to digital conversion, for example, digital signals received via a universal serial bus (USB) interface 146.

Field programmable gate array 108 can provide instructions which are acted upon by controller 109 for processing data received from the A/V input selector 138 or the USB interface 146, depending on the type of data received. For example, if A/V data is received in an uncompressed form, FPGA 108 and controller 109 can control processing of A/V data by MPEG encoder/decoder 106 for MPEG compression prior to being sent to the record/playback interface 110. However, if A/V data is received in an MPEG compressed format, FPGA 108 and controller 109 can controllably couple the A/V data to the receive/playback interface 110. In either case the FPGA 108 can provide read/write instructions which are implemented by controller 109 and control record/playback interface 110, for storing the A/V data on buffer storage device 148.

MPEG encoder/decoder 106 can perform MPEG compression and decompression of digital A/V signals. For example, MPEG encoder/decoder 106 can receive digital A/V signals from A/D converter 104 or USB interface 146, compress the digital A/V signals using an MPEG compression format, and forward the compressed digital A/V signals to the receive/playback interface 110. The receive/playback interface 110 then can initiate storage of the compressed digital signals on storage 148.

Storage 148 can include one or more data storage devices. For example, a data storage device can be a magnetic storage medium, such hard disk drive (HDD), As an optical storage medium, such as a digital video disk (DVD), an electronic storage medium, such as random access memory (RAM), a magneto/optical storage medium, or any combination of storage devices.

During playback the receive/playback interface 110 can receive data A/V data read from storage 148. The A/V data then can be forwarded to MPEG encoder/decoder 106 for decompression. After decompression the A/V data can be separated into video and audio signals. The audio signal can be forwarded to SPDIF 116 to be output digitally via coaxial output 192 or optical output 194. The audio signal also can be forwarded to audio D/A converter 114 for D/A conversion. After D/A conversion the audio signal can be output via headphone jack 134 and/or left and right audio outputs 176 and 178.

The video signal can be processed by video digital encoder 112, which can perform D/A conversion of the digital video signal and form output video signals with a variety formats. For example, the replayed MPEG signal can be decoded and processed by encoder 112 to from individual R G B color signals. Similarly the decoded MPEG signal can be processed into luminance and encoded chrominance signals (Y+C), or alternatively processed to form a composite video signal, having an NTSC or PAL signal format. The composite video and the Y+C video signals can be coupled to video switch 160, while the R G B video signals can be coupled to the video overlay encoder 152.

The video overlay encoder 152 can comprise overlay module 154, NTSC or PAL video encoder 156, and Y Pb Pr matrix encoder 158. The overlay module 154 can receive program information from a program information module 150 and graphically overlay or insert the program information onto or within the video signal to facilitate an on screen display or OSD by a subsequent display device. The program information module 150 can extract the program information from an on-line program guide or a program guide contained in incoming A/V signals received by the A/V input selector 138 and communicated to the program information module 150 by the DSP 102. The program information can include available 10 programs for each channel as well as program scheduling. Further, for each individual program the program information can include a program identifier, channel information, recording time, program duration, scene data, program credits, etc. Other information and graphics may be overlaid or inserted into the video signal as well. For example, a clock, text blocks, user information, menus, 15 icons, pictures, etc. can be combined with the video signal for OSD. Typically, information is combined with the video signal when requested by a user or upon some pre-defined event. However, some information, such as a channel identifier, can be continually superimposed on the video signal.

The PAL or NTSC encoder can output the video signal as an encoded 20 composite video signal, as well as providing video separated into separate luminance and encoded chrominance signals. The video signals then can be coupled the video switch 160. The video switch 160 can be used to select for display either the encoded video signal or the video signal generated by the video encoder Denc 112. Composite video signals from either source can be output via composite video 25 output connector 174, while chrominance and luminance video signals from either source can be output via the S-video output connector 172.

The matrix encoder 158 can generate a Y Pb Pr formatted analog video signal. As previously noted, the Y Pb Pr video signal includes a video luminance (Y) component, an analog blue color difference (B-Y), and an analog red color 30 difference (R-Y). The Y component can be output to the Y output connector 182, the (B-Y) difference can be output to the Pb output connector 184 and the (R-Y) difference can be output to the Pr output connector 186.

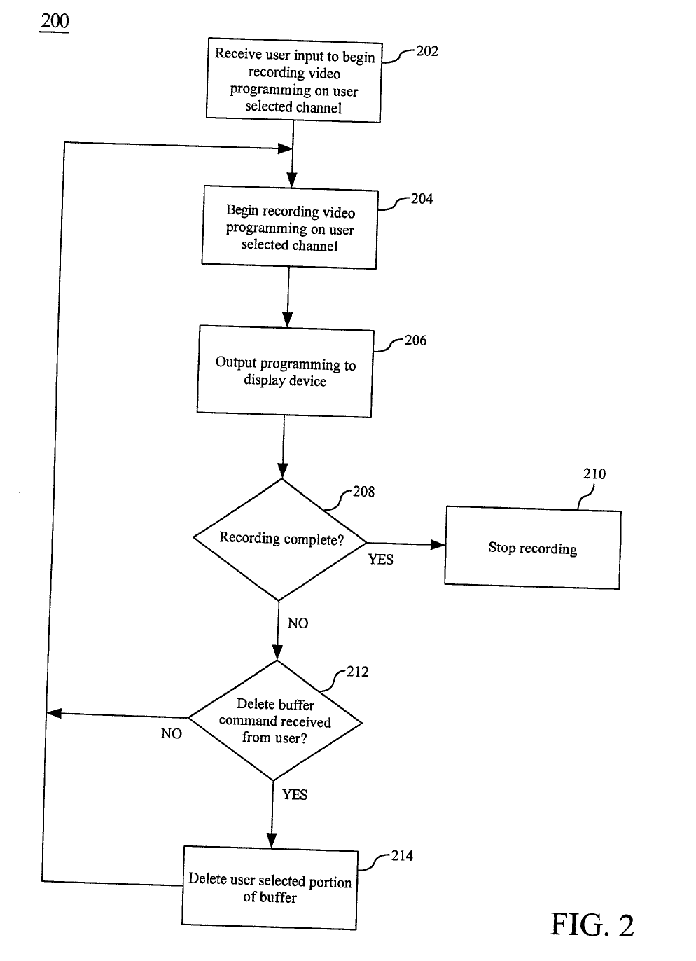

FIG. 2 is a flow chart 200 that is useful for understanding the inventive arrangements. Referring to step 202, personal video recorder 100 can receive a user input to begin recording broadcast audio video programming. The user input can be entered via keypad 122 or a remote control unit communicating with the IR remote control interface 126. Referring to step 204, the PVR 100 initiates recording the programming from a user selected channel on storage device 148. Concurrently, the programming also can be output to a video display device, as shown in step 206.

Further PVR arrangements also can be provided. For example, the PVR 100 can be configured to automatically commence recording of programming upon activation of the PVR 100. In one arrangement the channel selected for recording can be the channel being output to a video display. In another arrangement the channel being recorded can be a user-defined channel that is different from the channel being replayed for display. For example, a user can watch sports on a first channel while recording a movie received on a second channel. (Simultaneously playing back whilst recording).

When the channel being recorded is changed, the recording can follow the channel change. The previous channel's programming already recorded to storage 148 can be retained so that there is continuous recording of the prior channel programming up to the selection of the new channel. A user thus can replay and perform trick mode operations on programming recorded from multiple channels. For example, a user can view and record a sporting event on a first channel and later change the channel to a news broadcast. If the news broadcast makes reference to a particular play in the sporting event the user watched earlier, the user can rewind back to the sporting event to view the play. The user then can fast forward up to the point in the newscast where he left off and resume viewing the newscast without missing any of the content.

Referring to decision block 208 and step 210, recording can be stopped when the recording is complete. The recording can be determined to be complete when the PVR 100 is turned off, when the PVR 100 receives a user request to stop recording, or upon some pre-determined event.

Referring to decision block 212 and step 214, upon receiving a user request the PVR 100 can delete programming from storage 148. The user request can be entered via keypad 122 or a remote control unit communicating with the IR remote control interface 126. In one embodiment, the user can be automatically prompted to enter a delete buffer storage command when changing a current viewing channel that is being recorded. For example, if a user is viewing and recording a program containing adult content, the user can choose to erase the program from storage 148 when they have finished viewing the program. Thus, a child who later views another program with the PVR 100 cannot stumble across the adult content. In a further arrangement, the PVR 100 can be controlled to sequentially erase one segment of recorded programming with each push of an erase button. Hence, three pushes of an erase button can delete the last three program segments. The PVR 100 also can be disposed to erase programming from storage 148 upon deactivation of the PVR 100, i.e. at power off. Programming identified to be saved can be skipped during the erasing process.

In another arrangement, responsive to a user request the PVR 100 can provide an interactive erase menu comprising a list of erase options. The erase menu can be presented to the user on either display 124 or as an on screen display by the video display presenting the current programming. For example, a first menu selection can erase user specified program segments and in addition mark specific sections as protected and un-erasable unless specifically unprotected. A second menu selection can erase programming within user specified time frames and a third menu selection can erase all recorded programming with the exception of protected segments. Before erasing programming from storage device 148, the PVR 100 can provide an erase confirmation menu comprising an erase confirmation selection and a cancel selection. The PVR can proceed with the selected erase method if the user chooses the erase confirmation. The erase process can be canceled if the user chooses the cancel selection. Notably, playback of recorded programming can be paused during the erase selection process so that the user does not miss any program content while distracted.

It should be understood that the examples and embodiments described herein are for illustrative purposes only and that various modifications or changes in light thereof can be suggested by persons skilled in the art and are to be included within the spirit and purview of this application. The invention can take many other specific forms without departing from the spirit or essential attributes thereof for an indication of the scope of the invention.

What is claimed is:

1. In a recording device that continuously buffers audio/video programming responsive to a user selected input source, a method for maintaining user privacy, comprising:
continuously recording said programming on a data storage medium responsive to said user selected source;
providing said programming to a display device concurrently with said recording step; and,
selectively deleting, responsive to a user input, at least a portion of said programming stored on said data storage medium.

2. The method according to claim 1, wherein said user input is comprised of a single command input.

3. The method according to claim 1, wherein said single command input is a single actuation of a control key.

4. The method according to claim 1, wherein said at least a portion selectively deleted is controlled by a pre-determined number of control key actuations.

5. The method according to claim 1, wherein all said programming is deleted from said data storage medium.

6. The method according to claim 1, wherein all un-protected programming is deleted from said data storage medium.

7. The method according to claim 1 wherein said at least a portion of said programming deleted from said data storage medium is determined responsive to a user input.

8. The method according to claim 1, wherein said selectively deleting step, comprises providing an erase menu for display listing erase options for user selection.

9. The method according to claim 8, wherein said menu options comprise:
selecting a first option erasing user specified program segments;
selecting a second option for enabling and disabling protection of user specified program segments from erasure,
selecting a third option for erasing programming within user specified times; and,
selecting a fourth option for erasing all unprotected recorded programming.

10. The method according to claim 1, wherein said recording step continues uninterrupted during and subsequent to changing said selected source.

11. The method according to claim 1, wherein said selectively deleting step further comprises enabling said selectively deletion in accordance with changing said selected source.

12. The method according to claim 1, wherein said selectively deleting step further comprises deleting less than an entire portion of said programming that has been recorded responsive to changing said selected video channel.

13. In a recording system that continuously buffers audio video programming responsive to a user selected program source, a system for maintaining user privacy, comprising:
a data storage medium being continuously recorded with said audio video programming from said user selected program source;
a display signal generator generating signals representative of said programming concurrently with said program recording; and,
a controller responsive to user input for controlling selective deletion of at least a portion of said program recorded on said data storage medium.

14. The system according to claim 13 wherein said controller is configured to delete said at least a portion of said video programming in accordance with a single input command.

15. The system according to claim 13 wherein said controller is configured to delete said at least a portion of said programming in accordance with a single actuation of a control key.

16. The system according to claim 13 wherein said controller is configured to delete said at least a portion of said video programming upon a pre-determined number of actuations of a control key.

17. The system according to claim 13 wherein said controller is configured to delete all of said video programming from said data storage medium upon a command input.

18. The system according to claim 13 wherein said controller is configured to delete a user selected portion of said programming responsive to a user input.

19. The system according to claim 13 wherein response to a user input said display signal generator generates a menu of erase options for display.

20. The system according to claim 18 wherein said list of erase menu comprises ones of erasing user specified program segments; protecting user specified program segments from erasure, erasing specified program segments within specified times and, a erasing all un-protected programming.

21. The system according to claim 13 wherein said raid controller is configured to continue recording said programming substantially without interruption during and subsequent to a change of said selected program source.
